(19) United States
(12) Patent Application Publication
(10) Pub. No.: US 2017/0098067 A1
(43) Pub. Date: Apr. 6, 2017

(54) SYSTEMS AND METHODS FOR USER AUTHENTICATION

(71) Applicant: Facebook, Inc., Menlo Park, CA (US)

(72) Inventors: Balamanohar Paluri, Menlo Park, CA (US); Nikhil Johri, Mountain View, CA (US)

(21) Appl. No.: 14/873,068

(22) Filed: Oct. 1, 2015

(51) Int. Cl. G06F 21/36; G06N 3/08

(52) U.S. Cl. CPC G06F 21/36; G06N 3/08

(57) ABSTRACT

Systems, methods, and non-transitory computer-readable media can determine at least one operation that causes a challenge-response test to be activated for authenticating a user. A first set of content items that each have a threshold similarity to a query content item can be determined. A second set of content items that each have a threshold dissimilarity to the query content item can be determined. The challenge-response test can be provided for display to the user. The challenge-response test presents a group of content items including the first set of content items and the second set of content items.

### FIELD OF THE INVENTION

The present technology relates to the field of computing security. More particularly, the present technology relates to techniques for authenticating users.

### BACKGROUND

Today, people often utilize computing devices (or systems) for a wide variety of purposes. Users can use their computing devices, for example, to interact with one another, create content, share content, and view content. In some cases, a user can utilize his or her computing device to access a social networking system (or service). The user can provide, post, share, and access various content items, such as status updates, images, videos, articles, and links, via the social networking system.

In some instances, however, illegitimate users may attempt to perform illegitimate or undesirable operations on the social networking system. Under conventional approaches, security measures can be implemented in attempt to prevent or reduce the occurrence of illegitimate or undesirable operations. However, such conventional security measures can often times be burdensome or create obstacles for legitimate users that are performing legitimate or permitted operations. Accordingly, such conventional approaches can be inconvenient to users and may not be effective in addressing these and other problems arising in computer technology.

### SUMMARY

Various embodiments of the present disclosure can include systems, methods, and non-transitory computer readable media configured to determine at least one operation that causes a challenge-response test to be activated for authenticating a user. A first set of content items that each have a threshold similarity to a query content item can be determined. A second set of content items that each have a threshold dissimilarity to the query content item can be determined. The challenge-response test can be provided for display to the user. The challenge-response test presents a group of content items including the first set of content items and the second set of content items.

In an embodiment, systems, methods, and non-transitory computer readable media can be configured to determine a number of content items to be included in the first set, determine a respective similarity distance measurement between the query content item and each of a plurality of content items, and select content items from the plurality of content items to be included in the first set, wherein the respective similarity distance measurement of each of the selected content items satisfies a first threshold range.

In an embodiment, systems, methods, and non-transitory computer readable media can be configured to determine a number of content items to be included in the second set, determine a respective similarity distance measurement between the query content item and each of a plurality of content items, and select content items from the plurality of content items to be included in the second set, wherein the respective similarity distance measurement of each of the selected content items satisfies a second threshold range.

In an embodiment, systems, methods, and non-transitory computer readable media can be configured to determine the respective similarity distance measurement between a hash value corresponding to the query content item and a respective hash value corresponding to the content item.

In an embodiment, the similarity distance measurement is a Hamming distance between the hash value corresponding to the query content item and the respective hash value corresponding to the content item.

In an embodiment, the hash values are projected using a convolutional neural network.

In an embodiment, the convolutional neural network is trained to project the hash values based at least in part on locality-sensitive hashing.

In an embodiment, systems, methods, and non-transitory computer readable media can be configured to determine that a threshold number of users have identified a particular content item included in the second set of content items as being similar to the query content item and train the convolutional neural network so that the particular content item is determined to be similar to the query content item.

In an embodiment, the challenge-response test is satisfied when a threshold number of similar content items from the group of content items have been identified. Systems, methods, and non-transitory computer readable media can be configured to determine that the user has identified the threshold number of content items in the first set and perform the at least one operation.

In an embodiment, the challenge-response test is satisfied when a threshold number of content items similar to the query content item have been identified from the group of content items. Systems, methods, and non-transitory computer readable media can be configured to determine that the user has identified the threshold number of content items in the first set and perform the at least one operation.

It should be appreciated that many other features, applications, embodiments, and/or variations of the disclosed technology will be apparent from the accompanying drawings and from the following detailed description. Additional and/or alternative implementations of the structures, systems, non-transitory computer readable media, and methods described herein can be employed without departing from the principles of the disclosed technology.

### BRIEF DESCRIPTION OF THE DRAWINGS

FIG. 1 illustrates an example system including an example authentication module configured to authenticate users, according to an embodiment of the present disclosure.

FIG. 2 illustrates an example challenge-response module configured to provide challenge-response security measures for authenticating users, according to an embodiment of the present disclosure.

FIG. 3A illustrates an example diagram for generating hash values, according to an embodiment of the present disclosure.

FIG. 3B illustrates an example diagram for obtaining a set of content items for a visual captcha, according to an embodiment of the present disclosure.

FIG. 4 illustrates an example of a visual captcha, according to an embodiment of the present disclosure.

FIG. 5 illustrates another example of a visual captcha, according to an embodiment of the present disclosure.

FIG. 6 illustrates an example method for generating a visual captcha, according to an embodiment of the present disclosure.

FIG. 7 illustrates a network diagram of an example system including an example social networking system that can be utilized in various scenarios, according to an embodiment of the present disclosure.

FIG. 8 illustrates an example of a computer system or computing device that can be utilized in various scenarios, according to an embodiment of the present disclosure.

The figures depict various embodiments of the disclosed technology for purposes of illustration only, wherein the figures use like reference numerals to identify like elements. One skilled in the art will readily recognize from the following discussion that alternative embodiments of the structures and methods illustrated in the figures can be employed without departing from the principles of the disclosed technology described herein.

### DETAILED DESCRIPTION

### Security Measures for User Authentication

People use computing devices (or systems) for a wide variety of purposes. For example, users can utilize their computing devices to produce information, access information, and share information. In some cases, users can utilize computing devices to interact or engage with a social networking system (e.g., a social networking service, a social network, etc.). For example, users can provide, post, or publish content items, such as text, notes, status updates, links, pictures, videos, and audio, through the social networking system. In some instances, there may be illegitimate users (e.g., spam bots) that seek to perform illegitimate (e.g., malicious) operations including, for example, phishing, posting malicious or other harmful links through the social networking system, etc.

Under conventional approaches, security measures can be implemented in attempt to prevent or reduce such illegitimate operations. In one example, when a potentially illegitimate operation is detected, conventional security measures can test the user performing the illegitimate operation using a Completely Automated Public Turing test to tell Computers and Humans Apart (“captcha”). In one example, a text-based captcha may require a user to correctly input text that is displayed in the captcha. However, often times the legibility of the text can be low even for legitimate users (e.g., humans) and, therefore, result in such legitimate users failing the challenge posted by the captcha. Further, such security measures may be defeated by illegitimate users (e.g., spam bots, machines, computer programs, etc.), for example, by utilizing optical character recognition (OCR) processes. In some instances, a visual (e.g., image-based) captcha can be utilized and may require a user to correctly identify images that correspond to a certain concept (e.g., “select all images that show a flower”). Such concept-based approaches, however, may create difficulties for some users due to cultural, regional, and/or language differences. Moreover, such concept-based approaches may cause confusion among users when the images presented in the captcha include additional entities in the captured subject matter. For example, some confusion may result if the captcha asks the user to select all images that depict a flower and one of the images presented in the captcha includes a flower and a tree.

An improved approach rooted in computer technology overcomes the foregoing and other disadvantages associated with conventional approaches specifically arising in the realm of computer technology. For example, a social networking system may determine that a process for authenticating a user is to be initiated. In various embodiments, a concept-free visual Completely Automated Public Turing test to tell Computers and Humans Apart (“visual captcha”) (i.e., a challenge-response authentication test) can be utilized to authenticate the user. The visual captcha can be generated by obtaining a group of content items (e.g., images), for example, using a query content item. The group of content items can include a first set of content items that have a threshold level of similarity to the query content item as well as a second set of content items that are not similar to the query content item. During the authentication process, the user can be presented with the group of content items, together with a prompt that asks the user to identify all of the content items that are similar to one another (e.g., the content items that capture similar subject matter). The user can successfully satisfy the authentication process if the user correctly identifies (e.g., checks a respective “yes” or “no” box for each content item) which content items in the group are similar. Thus, the improved approach is concept agnostic in that the approach allows authentication of users without requiring users to identify, or select, content items based on an identified concept. Instead, users can be asked to identify content items based on their visual features.

In some embodiments, the accuracy with which the user identifies similar content items can vary depending on some pre-determined threshold. For example, if the visual captcha includes 10 images with 4 of the images being similar, then, in some implementations, the user may still successfully satisfy the authentication process if the user correctly identifies at least a threshold number (e.g., 3) of the similar images. Other variations are possible. For example, in some embodiments, the authentication process may require (i.e., challenge) the user to identify all of the content items in the group that are similar to the query content item within some threshold level of accuracy, or to identify all of the content items in the group that are dissimilar within some threshold level of accuracy, or to identify all of the content items in the group that are dissimilar from the query content item within some threshold level of accuracy, to provide some examples.

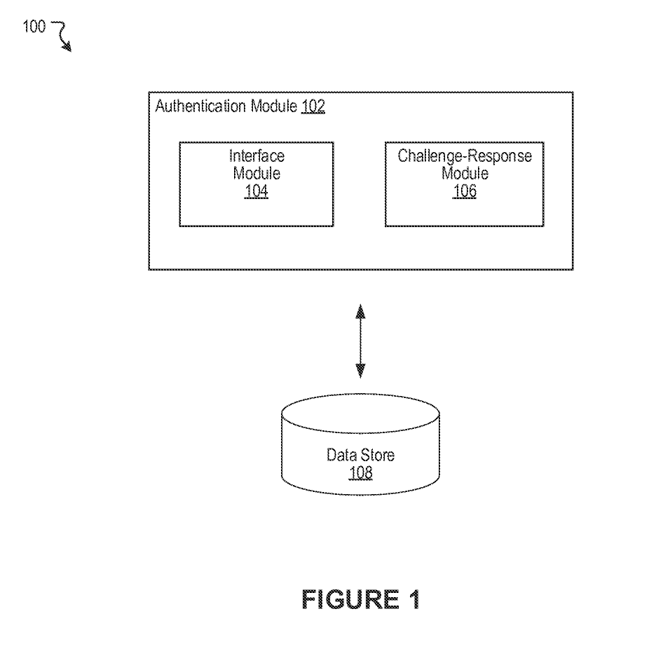

FIG. 1 illustrates an example system 100 including an example authentication module 102 configured to authenticate users, according to an embodiment of the present disclosure. As shown in the example of FIG. 1, the authentication module 102 can include an interface module 104 and a challenge-response module 106. In some instances, the example system 100 can include at least one data store 108. The components (e.g., modules, elements, etc.) shown in this figure and all figures herein are exemplary only, and other implementations may include additional, fewer, integrated, or different components. Some components may not be shown so as not to obscure relevant details.

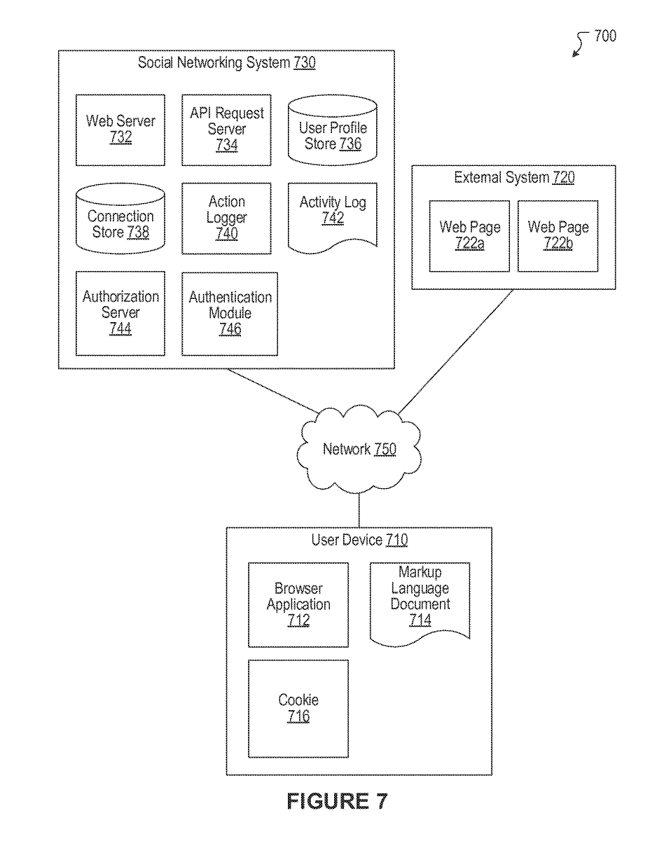

In some embodiments, the authentication module 102 can be implemented, in part or in whole, as software, hardware, or any combination thereof. In general, a module as discussed herein can be associated with software, hardware, or any combination thereof. In some implementations, one or more functions, tasks, and/or operations of modules can be carried out or performed by software routines, software processes, hardware, and/or any combination thereof. In some cases, the authentication module 102 can be implemented, in part or in whole, as software running on one or more computing devices or systems, such as on a user or client computing device. For example, the authentication module 102 or at least a portion thereof can be implemented as or within an application (e.g., app), a program, or an applet, etc., running on a user computing device or a client computing system, such as the user device 710 of FIG. 7. In another example, the authentication module 102 or at least a portion thereof can be implemented using one or more computing devices or systems that include one or more servers, such as network servers or cloud servers. In some instances, the authentication module 102 can, in part or in whole, be implemented within or configured to operate in conjunction with a social networking system (or service), such as the social networking system 730 of FIG. 7. It should be understood that there can be many variations or other possibilities.

In some embodiments, the authentication module 102 can be configured to communicate and/or operate with the at least one data store 108, as shown in the example system 100. The at least one data store 108 can be configured to store and maintain various types of data. In various embodiments, the data store 108 can store data relevant to the function and operation of the authentication module 102. Examples of such data include content items and respective hash values corresponding to the content items as determined, for example, using a neural network. In some implementations, the at least one data store 108 can store information associated with the social networking system (e.g., the social networking system 730 of FIG. 7). The information associated with the social networking system can include data about users, social connections, social interactions, locations, geo-fenced areas, maps, places, events, pages, groups, posts, communications, content, feeds, account settings, privacy settings, a social graph, and various other types of data. In some implementations, the at least one data store 108 can store information associated with users, such as user identifiers, user information, profile information, user locations, user specified settings, content produced or posted by users, and various other types of user data. It should be appreciated that there can be many variations or other possibilities.

In various embodiments, when an authentication process is initiated for a user, the interface module 104 can be configured to present a visual captcha that is used to authenticate the user. For example, the authentication process may be triggered when the user attempts to perform one or more restricted operations (e.g., changing a login password, accessing private information, logging in from an unrecognized computing device, etc.). In various embodiments, the visual captcha can include a group of content items (e.g., images, animated images, videos, audio files, etc.) that are presented to the user. The content items included in the group may or may not be of the same type. The visual captcha can also prompt, or challenge, the user to perform one or more actions as part of the authentication process. For example, the visual captcha can instruct the user to identify all of the similar content items in the group of content items that were presented with the visual captcha. The authentication process can be satisfied once the user correctly indicates (e.g., checks a respective “yes” or “no” box for each image) which of the content items in the group are similar. That is, the authentication process can be satisfied once the user correctly identifies the content items that capture similar subject matter. For example, the group of images included in the visual captcha may include four different images that include various representations of a sunflower and six different images that capture other, different subject matter (e.g., pizza, basketball, a mountainous landscape, baseball player, a car, and a laptop). In this example, if the user identifies the four images that include the various representations of the sunflower, then the authentication process is satisfied. As mentioned, in some embodiments, the accuracy with which the user identifies similar content items can vary depending on a specified threshold. For example, in some implementations, the user may still successfully satisfy the authentication process if the user correctly identifies at least a threshold number (e.g., three) of the images that include representations of the sunflower.

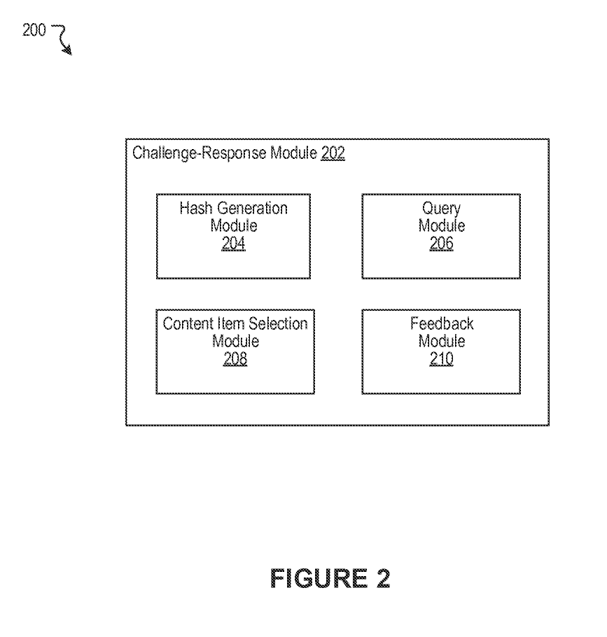

The challenge-response module 106 can be configured to generate visual captchas. In some embodiments, the challenge-response module 106 can generate the visual captcha by obtaining a group of content items, for example, using a query content item, as described in reference to FIG. 2. Further, a first set of content items included in the group can be similar to one another (e.g., the content items capture similar subject matter), for example, based on a threshold level of similarity. Additionally, the group of content items can also include a second set of content items that are not similar to the content items included in the first set. The visual captcha can also prompt, or challenge, the user to perform one or more actions as part of the authentication process. In some embodiments, the visual captcha can instruct the user to identify all, or a threshold number, of the visually similar content items in the group of content items that were presented with the visual captcha. As mentioned, the authentication process may be triggered when the user attempts to perform one or more restricted operations. Once the user satisfies the authentication process, for example, by identifying all, or a threshold number, of the visually similar content items, then the restricted operations may be permitted and/or executed, for example, by a computing device.

Other variations are possible. For example, in some embodiments, the visual captcha may require (i.e., challenge) the user to identify, within some threshold level of accuracy, all of the content items in the group that are similar to the query content item. In some embodiments, the visual captcha may require the user to identify, within some threshold level of accuracy, all of the content items in the group that are dissimilar. In some embodiments, the visual captcha may require the user to identify, within some threshold level of accuracy, all of the content items in the group that are dissimilar from the query content item. More details regarding the challenge-response module 106 will be provided below in reference to FIG. 2.

FIG. 2 illustrates an example challenge-response module 202 configured to provide challenge-response security measures for authenticating users, according to an embodiment of the present disclosure. In some embodiments, the challenge-response module 106 of FIG. 1 can be implemented with the challenge-response module 202. As shown in the example of FIG. 2, the challenge-response module 202 can include a hash generation module 204, a query module 206, a content item selection module 208, and a feedback module 210.

As mentioned, the challenge-response module 202 can be configured to generate visual captchas to be used for authenticating users. A visual captcha can include a group of content items that are presented to the user being authenticated along with a challenge. In some embodiments, the group of content items to be included in the visual captcha can be determined based at least in part on a query content item. For example, when determining the group of content items, the challenge-response module 202 can determine or obtain respective hash values for various content items that may potentially be included in the visual captcha. Next, the challenge-response module 202 can determine a respective similarity distance measurement between the query content item and each of the various content items that are available to be included in the visual captcha. In some embodiments, the distance measurement between two content items can be determined by computing a distance (e.g., a Hamming distance) between the respective hash values of the two content items. As mentioned, the group of content items included in the visual captcha can include a first set of content items that are similar to one another (e.g., the content items capture similar subject matter), for example, based on a threshold level of similarity (e.g., a first threshold Hamming distance range) or that are similar to the query content item, for example, based on a first threshold level of similarity. Additionally, the group of content items can also include a second set of content items that are not similar to the content items included in the first set (e.g., a second threshold Hamming distance range) or that are dissimilar to the query content item, for example, based on a second threshold level of similarity.

The hash generation module 204 can be configured to determine respective hash values for various content items that may be included in a visual captcha. For example, the various content items that are available to be included in a visual captcha may be part of a collection, or pool, of content items that have been curated and/or obtained automatically through a system (e.g., a social networking system). In some embodiments, hash values for content items can be determined using a convolutional neural network (CNN). The CNN can include one or more convolutional layers, pooling layers, and fully-connected layers, for example. The CNN can also include a projection layer that is trained to determine, or project, respective hash values for content items submitted to the CNN. In various embodiments, the hash value generated by the projection layer for a given content item provides a numerical (e.g., binary), or alphanumerical, representation of the subject matter captured by that content item. In some embodiments, the projection layer can be trained using locality sensitive hashing (LSH) techniques, so that the hash values generated for any two content items can be used to gauge the similarity of the respective subject matter captured by the two content items. Thus, in some embodiments, a hash value generated for a first content item will be the same as a hash value generated for a second content item that is identical in subject matter to the first content item. The use of a CNN to generate the hash values is just one example approach and different approaches may be utilized depending on the implementation. For example, the hash values may be generated using any approach that can provide a numerical, or alphanumerical, representation of the subject matter captured by content items, so that the hash values generated for any two content items can be used to gauge the similarity of the respective subject matter captured by those two content items. For example, in some embodiments, a Siamese neural network may be trained to generate such hash values.

The respective lengths of the hash values generated by the hash generation module 204 can vary depending on the implementation. In one example, each generated hash value can be 256 bits (or 8 bytes) in length. In some embodiments, the hash generation module 204 is used to generate the respective hash values for the various content items that are available to be utilized in visual captchas as part of an offline process. In such embodiments, each of these content items can be associated with its corresponding hash value and such associations can be stored, for example, in the data store 108 of FIG. 1. Such associations can be utilized, for example, so that the distance measurements (e.g., Hamming distances) between content items can be determined without having to compute the hash values each time a visual captcha is being generated.

As mentioned, in some embodiments, the group of content items to be included in a visual captcha are determined using a query content item. The query module 206 can be configured to randomly select a query content item when a visual captcha is being generated. The query content item may be selected from the various content items that are available to be included in visual captchas. Such content items may be part of a collection, or pool, of content items that have been curated and/or obtained automatically through a system (e.g., a social networking system).

The content item selection module 208 can be configured to utilize the query content item selected by the query module 206 to identify content items to be included in the visual captcha. When determining which content items to include in the visual captcha, the content item selection module 208 can determine a respective pairwise distance measurement between the query content item and each of (or a threshold number of) the content items that are available to be included in the visual captcha. The distance measurement between two content items can be determined by computing a distance between the respective hash values of the two content items. In some embodiments, the distance is measured using a Hamming distance that measures the difference (e.g., bit-by-bit difference) between two hash values. A distance determined for a given content item provides a measure of similarity between the given content item and the query content item. Such distances can be utilized by the content item selection module 208 to determine which content items to include in the visual captcha.

In some embodiments, a content item can be selected for inclusion in a visual captcha when the respective distance between the content item and the query content item satisfies a threshold value or range. For example, the content item selection module 208 may utilize a first threshold distance range (e.g., a Hamming distance between 20 to 60) for identifying content items that are similar to the query content item. Further, the content item selection module 208 may utilize a second threshold distance range (e.g., a Hamming distance between 80 to 256) for identifying content items that are not similar to the query content item. When generating a visual captcha, in some embodiments, the content item selection module 208 can determine the number of content items to be included in the visual captcha at the time the visual captcha is being generated. Similarly, the content item selection module 208 can also determine the number of similar content items to include in the visual captcha. Thus, for example, the content item selection module 208 can determine that a total of 10 content items are to be included in the visual captcha and that 3 of those content items will be similar to one another with respect to their subject matter. The content item selection module 208 can select the similar content items by evaluating the respective distances of the various content items that are available to be included in the visual captcha and selecting the appropriate number of similar content items that have a respective distance that satisfies the first threshold range. In this example, the content item selection module 208 can select three content items that satisfy the first threshold range. In other words, the content item selection module 208 will select three content items that are visually similar to one another within some threshold distance measure.

Similarly, the content item selection module 208 can select the remaining content items to be included in the visual captcha by evaluating the respective distances of the various content items that are available to be included in the visual captcha and selecting the appropriate number of different content items that have a respective distance that satisfies the second threshold range. In this example, the content item selection module 208 can select seven content items that satisfy the second threshold range. In other words, the content item selection module 208 will select seven content items that are not visually similar to the three selected similar content items within some threshold distance measure. As mentioned, the content items that may be included in the visual captcha may be obtained, for example, from the collection, or pool, of content items that have been curated and/or obtained automatically through a system (e.g., a social networking system).

In some embodiments, the content item selection module 208 can also determine a prompt, or challenge, to be included with the visual captcha. The challenge can ask the user to perform one or more actions as part of the authentication process. In some embodiments, the content item selection module 208 can include a challenge that instructs the user to identify all of the similar content items in the group of content items that are presented with the visual captcha. In some embodiments, the visual captcha presents the query content item and instructs the user to identify all of the content items in the group of content items that were presented with the visual captcha that are similar to the query content item.

The feedback module 210 can be configured to evaluate user selections of similar (or dissimilar) content items in visual captchas, and to utilize such content item classification information for refining the hash generation module 204 and/or the CNN utilized for purposes of generating hash values for content items. For example, based on the hash values generated for a query content item and a first content item by the CNN utilized by the hash generation module 204, the distance measure between the query content item and the first content item may be determined to be 90, which indicates that the query content item and the first content item are generally not visually similar. However, if a threshold number of users continue to identify the first content item and the query content item as being similar in visual captchas, then the feedback module 210 can utilize such information for purposes for refining, or retraining, the CNN utilized by the hash generation module 204 so that the distance between the query content item and the first content item is reduced to reflect such similarity between the two content items. In other words, the CNN can be refined so that the hash values generated for the query content item and/or the first content item reflect a reduced distance measure between the two content items.

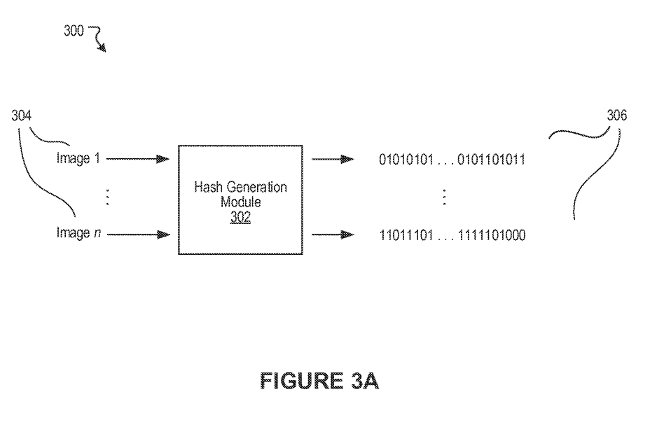

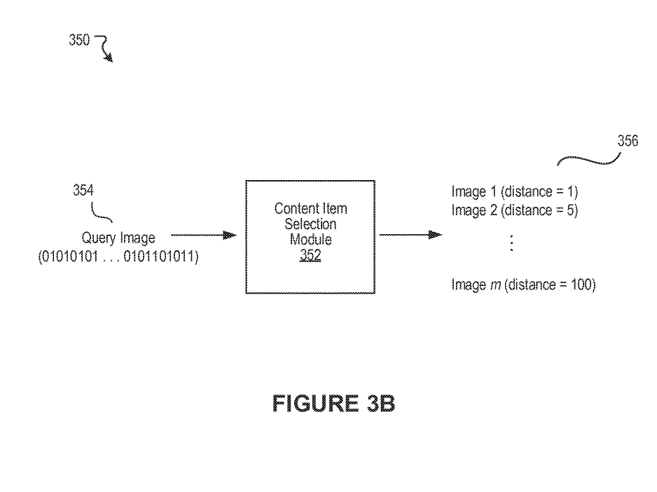

FIG. 3A illustrates an example diagram 300 for generating hash values, according to an embodiment of the present disclosure. In this example, the diagram 300 includes a hash generation module 302 that is configured to generate hash values for content items 304, such as images. In some embodiments, the hash generation module 204 of FIG. 2 can be implemented with the hash generation module 302.

In the example of FIG. 3A, the hash generation module 302 can determine respective hash values 306 for various content items 304 that may be included in a visual captcha. The hash values 306 generated by the hash generation module 302 for content items 304 can provide a numerical, or alphanumerical, representation of the subject matter captured by those content items 304. In various embodiments, the hash values for the content items 304 can be used to determine a respective similarity distance measurement between two content items. Such distance measurements can be used to select content items for inclusion in a visual captcha, as described above.

FIG. 3B illustrates an example diagram 350 for obtaining a set of content items 356 for a visual captcha, according to an embodiment of the present disclosure. In this example, the diagram 350 includes a content item selection module 352 that is configured to select content items to be included in a visual captcha. In some embodiments, the content item selection module 208 of FIG. 2 can be implemented with the content item selection module 352.

In the example of FIG. 3B, the content item selection module 352 can utilize a query content item 354, for example, as determined using the query module 206 of FIG. 2, to identify content items 356 that may be included in the visual captcha. When determining which content items to include in the visual captcha, the content item selection module 352 can determine a respective pairwise distance measurement between the query content item 354 and each of (or a threshold number of) the content items 356 that are available to be included in the visual captcha. The distance measurement between two content items can be determined by computing a distance between the respective hash values of the two content items. In some embodiments, the distance measurement is a Hamming distance. The distances determined for the content items 356 provide a measure of similarity between a given content item and the query content item 354. Such distances can be utilized by the content item selection module 352 to determine which content items to include in the visual captcha, as described above.

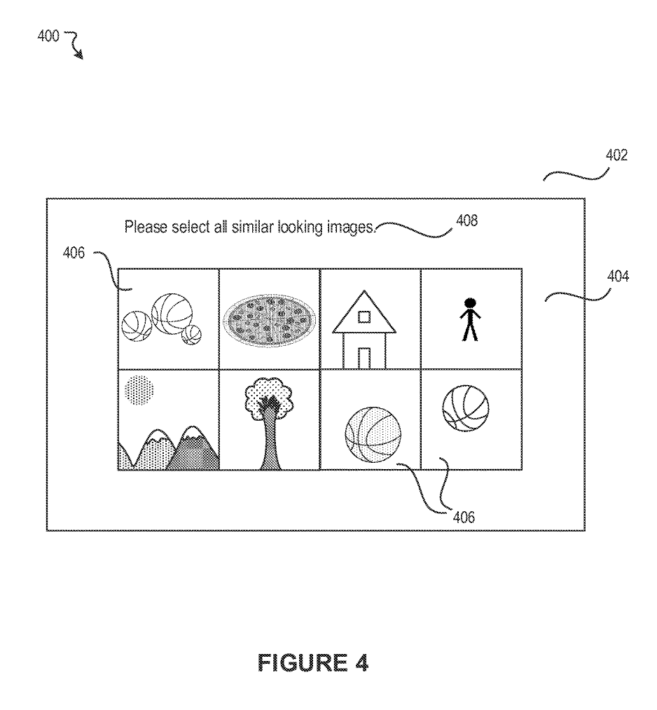

FIG. 4 illustrates an example 400 of a visual captcha 402, according to an embodiment of the present disclosure. The visual captcha 402 includes a group of content items 404 that are presented along with a challenge 408. As mentioned, the visual captcha 402 can be presented to a user when a process to authenticate the user is triggered.

In this example, the challenge 408 requests the user to select all of the content items in the group 404 that look similar to one another. The user can select content items in the visual captcha 402 in a number of different ways depending on the implementation including, for example, by selecting a checkbox, selecting respective “yes” or “no” box for each content item, clicking on the content items, performing a gesture (e.g., tap gesture), to name some examples. In the example of FIG. 4, the user can satisfy the challenge 408 posed by the visual captcha 402 by selecting the similar content items 406. Thus, the challenge 408 posed by the visual captcha 402 can be satisfied if the user selects all three of the content items 406. As mentioned, in some embodiments, the accuracy with which the user identifies similar content items 406 can vary depending on some pre-determined threshold. Thus, for example, if the accuracy threshold permitted the user to not accurately identify one content item, then the challenge 408 posed by the visual captcha 402 can still be satisfied if the user identified two of the three similar content items 406.

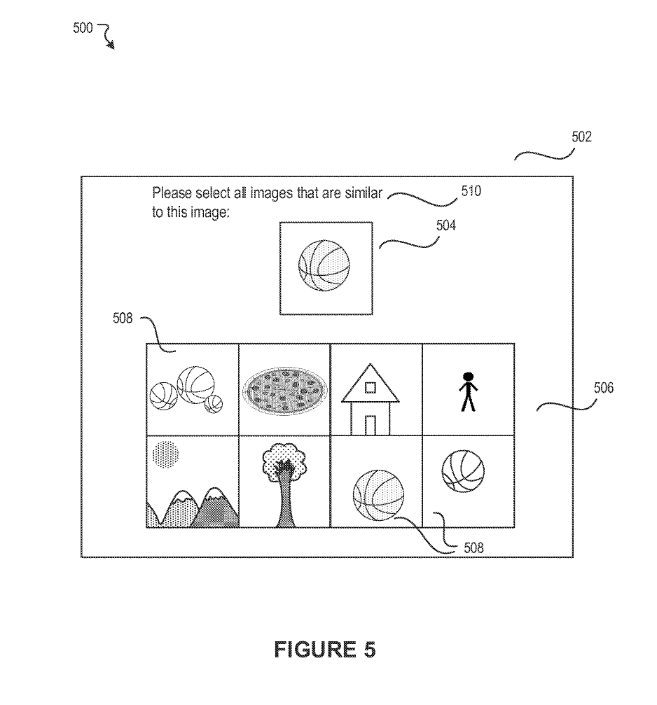

FIG. 5 illustrates another example 500 of a visual captcha, according to an embodiment of the present disclosure. The visual captcha 502 includes a query content item 504 and a group of content items 506 that are presented along with a challenge 510. As mentioned, the visual captcha 502 can be presented to a user when a process to authenticate the user is triggered.

In this example, the challenge 510 requests the user to select all of the content items in the group 506 that look similar to the query content item 504. In the example of FIG. 5, the user can satisfy the challenge 510 posed by the visual captcha 502 by selecting the content items 508 that are visually similar to the query content item 504. Thus, the challenge 510 posed by the visual captcha 502 can be satisfied if the user selects all three of the content items 508. However, as mentioned, in some embodiments, the accuracy with which the user identifies similar content items 508 can vary depending on some pre-determined threshold.

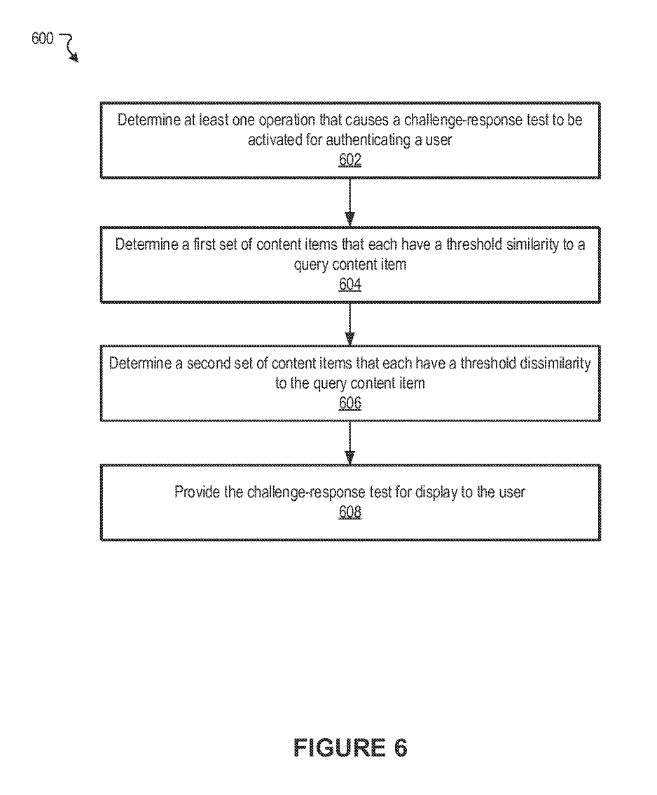

FIG. 6 illustrates an example method 600 for generating a visual captcha, according to an embodiment of the present disclosure. It should be appreciated that there can be additional, fewer, or alternative steps performed in similar or alternative orders, or in parallel, within the scope of the various embodiments discussed herein unless otherwise stated.

At block 602, the example method 600 can determine at least one operation that causes a challenge-response test to be activated for authenticating a user. At block 604, the method 600 can determine a first set of content items that each have a threshold similarity to a query content item. At block 606, the method 600 can determine a second set of content items that each have a threshold dissimilarity to the query content item. At block 608, the method 600 can provide the challenge-response test for display to the user. The challenge-response test presents a group of content items including the first set of content items and the second set of content items.

It is contemplated that there can be many other uses, applications, and/or variations associated with the various embodiments of the present disclosure. For example, in some cases, user can choose whether or not to opt-in to utilize the disclosed technology. The disclosed technology can also ensure that various privacy settings and preferences are maintained and can prevent private information from being divulged. In another example, various embodiments of the present disclosure can learn, improve, and/or be refined over time.

### Social Networking System—Example Implementation

FIG. 7 illustrates a network diagram of an example system 700 that can be utilized in various scenarios, in accordance with an embodiment of the present disclosure. The system 700 includes one or more user devices 710, one or more external systems 720, a social networking system (or service) 730, and a network 750. In an embodiment, the social networking service, provider, and/or system discussed in connection with the embodiments described above may be implemented as the social networking system 730. For purposes of illustration, the embodiment of the system 700, shown by FIG. 7, includes a single external system 720 and a single user device 710. However, in other embodiments, the system 700 may include more user devices 710 and/or more external systems 720. In certain embodiments, the social networking system 730 is operated by a social network provider, whereas the external systems 720 are separate from the social networking system 730 in that they may be operated by different entities. In various embodiments, however, the social networking system 730 and the external systems 720 operate in conjunction to provide social networking services to users (or members) of the social networking system 730. In this sense, the social networking system 730 provides a platform or backbone, which other systems, such as external systems 720, may use to provide social networking services and functionalities to users across the Internet.

The user device 710 comprises one or more computing devices (or systems) that can receive input from a user and transmit and receive data via the network 750. In one embodiment, the user device 710 is a conventional computer system executing, for example, a Microsoft Windows compatible operating system (OS), Apple OS X, and/or a Linux distribution. In another embodiment, the user device 710 can be a computing device or a device having computer functionality, such as a smart-phone, a tablet, a personal digital assistant (PDA), a mobile telephone, a laptop computer, a wearable device (e.g., a pair of glasses, a watch, a bracelet, etc.), a camera, an appliance, etc. The user device 710 is configured to communicate via the network 750. The user device 710 can execute an application, for example, a browser application that allows a user of the user device 710 to interact with the social networking system 730. In another embodiment, the user device 710 interacts with the social networking system 730 through an application programming interface (API) provided by the native operating system of the user device 710, such as iOS and ANDROID. The user device 710 is configured to communicate with the external system 720 and the social networking system 730 via the network 750, which may comprise any combination of local area and/or wide area networks, using wired and/or wireless communication systems.

In one embodiment, the network 750 uses standard communications technologies and protocols. Thus, the network 750 can include links using technologies such as Ethernet, 702.11, worldwide interoperability for microwave access (WiMAX), 3G, 4G, CDMA, GSM, LTE, digital subscriber line (DSL), etc. Similarly, the networking protocols used on the network 750 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the network 750 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

In one embodiment, the user device 710 may display content from the external system 720 and/or from the social networking system 730 by processing a markup language document 714 received from the external system 720 and from the social networking system 730 using a browser application 712. The markup language document 714 identifies content and one or more instructions describing formatting or presentation of the content. By executing the instructions included in the markup language document 714, the browser application 712 displays the identified content using the format or presentation described by the markup language document 714. For example, the markup language document 714 includes instructions for generating and displaying a web page having multiple frames that include text and/or image data retrieved from the external system 720 and the social networking system 730. In various embodiments, the markup language document 714 comprises a data file including extensible markup language (XML) data, extensible hypertext markup language (XHTML) data, or other markup language data. Additionally, the markup language document 714 may include JavaScript Object Notation (JSON) data, JSON with padding (JSONP), and JavaScript data to facilitate data-interchange between the external system 720 and the user device 710. The browser application 712 on the user device 710 may use a JavaScript compiler to decode the markup language document 714.

The markup language document 714 may also include, or link to, applications or application frameworks such as FLASH™ or Unity™ applications, the SilverLight™ application framework, etc.

In one embodiment, the user device 710 also includes one or more cookies 716 including data indicating whether a user of the user device 710 is logged into the social networking system 730, which may enable modification of the data communicated from the social networking system 730 to the user device 710.

The external system 720 includes one or more web servers that include one or more web pages 722a, 722b, which are communicated to the user device 710 using the network 750. The external system 720 is separate from the social networking system 730. For example, the external system 720 is associated with a first domain, while the social networking system 730 is associated with a separate social networking domain. Web pages 722a, 722b, included in the external system 720, comprise markup language documents 714 identifying content and including instructions specifying formatting or presentation of the identified content.

The social networking system 730 includes one or more computing devices for a social network, including a plurality of users, and providing users of the social network with the ability to communicate and interact with other users of the social network. In some instances, the social network can be represented by a graph, i.e., a data structure including edges and nodes. Other data structures can also be used to represent the social network, including but not limited to databases, objects, classes, meta elements, files, or any other data structure. The social networking system 730 may be administered, managed, or controlled by an operator. The operator of the social networking system 730 may be a human being, an automated application, or a series of applications for managing content, regulating policies, and collecting usage metrics within the social networking system 730. Any type of operator may be used.

Users may join the social networking system 730 and then add connections to any number of other users of the social networking system 730 to whom they desire to be connected. As used herein, the term “friend” refers to any other user of the social networking system 730 to whom a user has formed a connection, association, or relationship via the social networking system 730. For example, in an embodiment, if users in the social networking system 730 are represented as nodes in the social graph, the term “friend” can refer to an edge formed between and directly connecting two user nodes.

Connections may be added explicitly by a user or may be automatically created by the social networking system 730 based on common characteristics of the users (e.g., users who are alumni of the same educational institution). For example, a first user specifically selects a particular other user to be a friend. Connections in the social networking system 730 are usually in both directions, but need not be, so the terms “user” and “friend” depend on the frame of reference. Connections between users of the social networking system 730 are usually bilateral (“two-way”), or “mutual,” but connections may also be unilateral, or “one-way.” For example, if Bob and Joe are both users of the social networking system 730 and connected to each other, Bob and Joe are each other's connections. If, on the other hand, Bob wishes to connect to Joe to view data communicated to the social networking system 730 by Joe, but Joe does not wish to form a mutual connection, a unilateral connection may be established. The connection between users may be a direct connection; however, some embodiments of the social networking system 730 allow the connection to be indirect via one or more levels of connections or degrees of separation.

In addition to establishing and maintaining connections between users and allowing interactions between users, the social networking system 730 provides users with the ability to take actions on various types of items supported by the social networking system 730. These items may include groups or networks (i.e., social networks of people, entities, and concepts) to which users of the social networking system 730 may belong, events or calendar entries in which a user might be interested, computer-based applications that a user may use via the social networking system 730, transactions that allow users to buy or sell items via services provided by or through the social networking system 730, and interactions with advertisements that a user may perform on or off the social networking system 730. These are just a few examples of the items upon which a user may act on the social networking system 730, and many others are possible. A user may interact with anything that is capable of being represented in the social networking system 730 or in the external system 720, separate from the social networking system 730, or coupled to the social networking system 730 via the network 750.

The social networking system 730 is also capable of linking a variety of entities. For example, the social networking system 730 enables users to interact with each other as well as external systems 720 or other entities through an API, a web service, or other communication channels. The social networking system 730 generates and maintains the “social graph” comprising a plurality of nodes interconnected by a plurality of edges. Each node in the social graph may represent an entity that can act on another node and/or that can be acted on by another node. The social graph may include various types of nodes. Examples of types of nodes include users, non-person entities, content items, web pages, groups, activities, messages, concepts, and any other things that can be represented by an object in the social networking system 730. An edge between two nodes in the social graph may represent a particular kind of connection, or association, between the two nodes, which may result from node relationships or from an action that was performed by one of the nodes on the other node. In some cases, the edges between nodes can be weighted. The weight of an edge can represent an attribute associated with the edge, such as a strength of the connection or association between nodes. Different types of edges can be provided with different weights. For example, an edge created when one user “likes” another user may be given one weight, while an edge created when a user befriends another user may be given a different weight.

As an example, when a first user identifies a second user as a friend, an edge in the social graph is generated connecting a node representing the first user and a second node representing the second user. As various nodes relate or interact with each other, the social networking system 730 modifies edges connecting the various nodes to reflect the relationships and interactions.

The social networking system 730 also includes user-generated content, which enhances a user's interactions with the social networking system 730. User-generated content may include anything a user can add, upload, send, or “post” to the social networking system 730. For example, a user communicates posts to the social networking system 730 from a user device 710. Posts may include data such as status updates or other textual data, location information, images such as photos, videos, links, music or other similar data and/or media. Content may also be added to the social networking system 730 by a third party. Content “items” are represented as objects in the social networking system 730. In this way, users of the social networking system 730 are encouraged to communicate with each other by posting text and content items of various types of media through various communication channels. Such communication increases the interaction of users with each other and increases the frequency with which users interact with the social networking system 730.

The social networking system 730 includes a web server 732, an API request server 734, a user profile store 736, a connection store 738, an action logger 740, an activity log 742, and an authorization server 744. In an embodiment of the invention, the social networking system 730 may include additional, fewer, or different components for various applications. Other components, such as network interfaces, security mechanisms, load balancers, failover servers, management and network operations consoles, and the like are not shown so as to not obscure the details of the system.

The user profile store 736 maintains information about user accounts, including biographic, demographic, and other types of descriptive information, such as work experience, educational history, hobbies or preferences, location, and the like that has been declared by users or inferred by the social networking system 730. This information is stored in the user profile store 736 such that each user is uniquely identified. The social networking system 730 also stores data describing one or more connections between different users in the connection store 738. The connection information may indicate users who have similar or common work experience, group memberships, hobbies, or educational history. Additionally, the social networking system 730 includes user-defined connections between different users, allowing users to specify their relationships with other users. For example, user-defined connections allow users to generate relationships with other users that parallel the users' real-life relationships, such as friends, co-workers, partners, and so forth. Users may select from predefined types of connections, or define their own connection types as needed. Connections with other nodes in the social networking system 730, such as non-person entities, buckets, cluster centers, images, interests, pages, external systems, concepts, and the like are also stored in the connection store 738.

The social networking system 730 maintains data about objects with which a user may interact. To maintain this data, the user profile store 736 and the connection store 738 store instances of the corresponding type of objects maintained by the social networking system 730. Each object type has information fields that are suitable for storing information appropriate to the type of object. For example, the user profile store 736 contains data structures with fields suitable for describing a user's account and information related to a user's account. When a new object of a particular type is created, the social networking system 730 initializes a new data structure of the corresponding type, assigns a unique object identifier to it, and begins to add data to the object as needed. This might occur, for example, when a user becomes a user of the social networking system 730, the social networking system 730 generates a new instance of a user profile in the user profile store 736, assigns a unique identifier to the user account, and begins to populate the fields of the user account with information provided by the user.

The connection store 738 includes data structures suitable for describing a user's connections to other users, connections to external systems 720 or connections to other entities. The connection store 738 may also associate a connection type with a user's connections, which may be used in conjunction with the user's privacy setting to regulate access to information about the user. In an embodiment of the invention, the user profile store 736 and the connection store 738 may be implemented as a federated database.

Data stored in the connection store 738, the user profile store 736, and the activity log 742 enables the social networking system 730 to generate the social graph that uses nodes to identify various objects and edges connecting nodes to identify relationships between different objects. For example, if a first user establishes a connection with a second user in the social networking system 730, user accounts of the first user and the second user from the user profile store 736 may act as nodes in the social graph. The connection between the first user and the second user stored by the connection store 738 is an edge between the nodes associated with the first user and the second user. Continuing this example, the second user may then send the first user a message within the social networking system 730. The action of sending the message, which may be stored, is another edge between the two nodes in the social graph representing the first user and the second user. Additionally, the message itself may be identified and included in the social graph as another node connected to the nodes representing the first user and the second user.

In another example, a first user may tag a second user in an image that is maintained by the social networking system 730 (or, alternatively, in an image maintained by another system outside of the social networking system 730). The image may itself be represented as a node in the social networking system 730. This tagging action may create edges between the first user and the second user as well as create an edge between each of the users and the image, which is also a node in the social graph. In yet another example, if a user confirms attending an event, the user and the event are nodes obtained from the user profile store 736, where the attendance of the event is an edge between the nodes that may be retrieved from the activity log 742. By generating and maintaining the social graph, the social networking system 730 includes data describing many different types of objects and the interactions and connections among those objects, providing a rich source of socially relevant information.

The web server 732 links the social networking system 730 to one or more user devices 710 and/or one or more external systems 720 via the network 750. The web server 732 serves web pages, as well as other web-related content, such as Java, JavaScript, Flash, XML, and so forth. The web server 732 may include a mail server or other messaging functionality for receiving and routing messages between the social networking system 730 and one or more user devices 710. The messages can be instant messages, queued messages (e.g., email), text and SMS messages, or any other suitable messaging format.

The API request server 734 allows one or more external systems 720 and user devices 710 to call access information from the social networking system 730 by calling one or more API functions. The API request server 734 may also allow external systems 720 to send information to the social networking system 730 by calling APIs. The external system 720, in one embodiment, sends an API request to the social networking system 730 via the network 750, and the API request server 734 receives the API request. The API request server 734 processes the request by calling an API associated with the API request to generate an appropriate response, which the API request server 734 communicates to the external system 720 via the network 750. For example, responsive to an API request, the API request server 734 collects data associated with a user, such as the user's connections that have logged into the external system 720, and communicates the collected data to the external system 720. In another embodiment, the user device 710 communicates with the social networking system 730 via APIs in the same manner as external systems 720.

The action logger 740 is capable of receiving communications from the web server 732 about user actions on and/or off the social networking system 730. The action logger 740 populates the activity log 742 with information about user actions, enabling the social networking system 730 to discover various actions taken by its users within the social networking system 730 and outside of the social networking system 730. Any action that a particular user takes with respect to another node on the social networking system 730 may be associated with each user's account, through information maintained in the activity log 742 or in a similar database or other data repository. Examples of actions taken by a user within the social networking system 730 that are identified and stored may include, for example, adding a connection to another user, sending a message to another user, reading a message from another user, viewing content associated with another user, attending an event posted by another user, posting an image, attempting to post an image, or other actions interacting with another user or another object. When a user takes an action within the social networking system 730, the action is recorded in the activity log 742. In one embodiment, the social networking system 730 maintains the activity log 742 as a database of entries. When an action is taken within the social networking system 730, an entry for the action is added to the activity log 742. The activity log 742 may be referred to as an action log.

Additionally, user actions may be associated with concepts and actions that occur within an entity outside of the social networking system 730, such as an external system 720 that is separate from the social networking system 730. For example, the action logger 740 may receive data describing a user's interaction with an external system 720 from the web server 732. In this example, the external system 720 reports a user's interaction according to structured actions and objects in the social graph.

Other examples of actions where a user interacts with an external system 720 include a user expressing an interest in an external system 720 or another entity, a user posting a comment to the social networking system 730 that discusses an external system 720 or a web page 722a within the external system 720, a user posting to the social networking system 730 a Uniform Resource Locator (URL) or other identifier associated with an external system 720, a user attending an event associated with an external system 720, or any other action by a user that is related to an external system 720. Thus, the activity log 742 may include actions describing interactions between a user of the social networking system 730 and an external system 720 that is separate from the social networking system 730.

The authorization server 744 enforces one or more privacy settings of the users of the social networking system 730. A privacy setting of a user determines how particular information associated with a user can be shared. The privacy setting comprises the specification of particular information associated with a user and the specification of the entity or entities with whom the information can be shared. Examples of entities with which information can be shared may include other users, applications, external systems 720, or any entity that can potentially access the information. The information that can be shared by a user comprises user account information, such as profile photos, phone numbers associated with the user, user's connections, actions taken by the user such as adding a connection, changing user profile information, and the like.

The privacy setting specification may be provided at different levels of granularity. For example, the privacy setting may identify specific information to be shared with other users; the privacy setting identifies a work phone number or a specific set of related information, such as, personal information including profile photo, home phone number, and status. Alternatively, the privacy setting may apply to all the information associated with the user. The specification of the set of entities that can access particular information can also be specified at various levels of granularity. Various sets of entities with which information can be shared may include, for example, all friends of the user, all friends of friends, all applications, or all external systems 720. One embodiment allows the specification of the set of entities to comprise an enumeration of entities. For example, the user may provide a list of external systems 720 that are allowed to access certain information. Another embodiment allows the specification to comprise a set of entities along with exceptions that are not allowed to access the information. For example, a user may allow all external systems 720 to access the user's work information, but specify a list of external systems 720 that are not allowed to access the work information. Certain embodiments call the list of exceptions that are not allowed to access certain information a “block list”. External systems 720 belonging to a block list specified by a user are blocked from accessing the information specified in the privacy setting. Various combinations of granularity of specification of information, and granularity of specification of entities, with which information is shared are possible. For example, all personal information may be shared with friends whereas all work information may be shared with friends of friends.

The authorization server 744 contains logic to determine if certain information associated with a user can be accessed by a user's friends, external systems 720, and/or other applications and entities. The external system 720 may need authorization from the authorization server 744 to access the user's more private and sensitive information, such as the user's work phone number. Based on the user's privacy settings, the authorization server 744 determines if another user, the external system 720, an application, or another entity is allowed to access information associated with the user, including information about actions taken by the user.

In some embodiments, the social networking system 730 can include an authentication module 746. The authentication module 746 can, for example, be implemented as the authentication module 102 of FIG. 1. As discussed previously, it should be appreciated that there can be many variations or other possibilities. For example, in some instances, the authentication module 746 (or at least a portion thereof) can be included in the user device 710. Other features of the authentication module 746 are discussed herein in connection with the image-based security module 102.

### Hardware Implementation

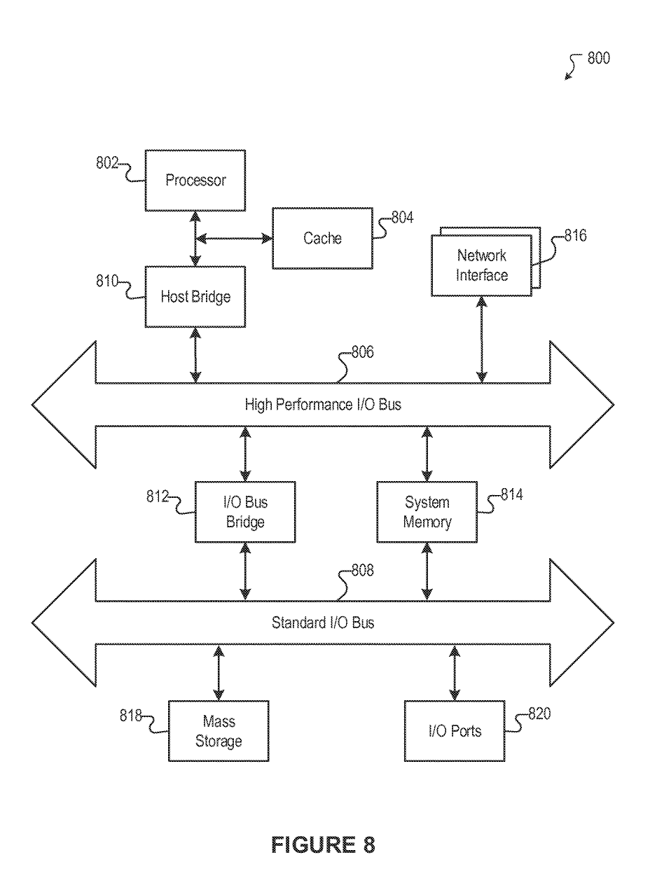

The foregoing processes and features can be implemented by a wide variety of machine and computer system architectures and in a wide variety of network and computing environments. FIG. 8 illustrates an example of a computer system 800 that may be used to implement one or more of the embodiments described herein in accordance with an embodiment of the invention. The computer system 800 includes sets of instructions for causing the computer system 800 to perform the processes and features discussed herein. The computer system 800 may be connected (e.g., networked) to other machines. In a networked deployment, the computer system 800 may operate in the capacity of a server machine or a client machine in a client-server network environment, or as a peer machine in a peer-to-peer (or distributed) network environment. In an embodiment of the invention, the computer system 800 may be the social networking system 730, the user device 710, and the external system 820, or a component thereof. In an embodiment of the invention, the computer system 800 may be one server among many that constitutes all or part of the social networking system 730.

The computer system 800 includes a processor 802, a cache 804, and one or more executable modules and drivers, stored on a computer-readable medium, directed to the processes and features described herein. Additionally, the computer system 800 includes a high performance input/output (I/O) bus 806 and a standard I/O bus 808. A host bridge 810 couples processor 802 to high performance I/O bus 806, whereas I/O bus bridge 812 couples the two buses 806 and 808 to each other. A system memory 814 and one or more network interfaces 816 couple to high performance I/O bus 806. The computer system 800 may further include video memory and a display device coupled to the video memory (not shown). Mass storage 818 and I/O ports 820 couple to the standard I/O bus 808. The computer system 800 may optionally include a keyboard and pointing device, a display device, or other input/output devices (not shown) coupled to the standard I/O bus 808. Collectively, these elements are intended to represent a broad category of computer hardware systems, including but not limited to computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

An operating system manages and controls the operation of the computer system 800, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Computer Inc. of Cupertino, Calif., UNIX operating systems, Microsoft® Windows® operating systems, BSD operating systems, and the like. Other implementations are possible.

The elements of the computer system 800 are described in greater detail below. In particular, the network interface 816 provides communication between the computer system 800 and any of a wide range of networks, such as an Ethernet (e.g., IEEE 802.3) network, a backplane, etc. The mass storage 818 provides permanent storage for the data and programming instructions to perform the above-described processes and features implemented by the respective computing systems identified above, whereas the system memory 814 (e.g., DRAM) provides temporary storage for the data and programming instructions when executed by the processor 802. The I/O ports 820 may be one or more serial and/or parallel communication ports that provide communication between additional peripheral devices, which may be coupled to the computer system 800.

The computer system 800 may include a variety of system architectures, and various components of the computer system 800 may be rearranged. For example, the cache 804 may be on-chip with processor 802. Alternatively, the cache 804 and the processor 802 may be packed together as a “processor module”, with processor 802 being referred to as the “processor core”. Furthermore, certain embodiments of the invention may neither require nor include all of the above components. For example, peripheral devices coupled to the standard I/O bus 808 may couple to the high performance I/O bus 806. In addition, in some embodiments, only a single bus may exist, with the components of the computer system 800 being coupled to the single bus. Moreover, the computer system 800 may include additional components, such as additional processors, storage devices, or memories.

In general, the processes and features described herein may be implemented as part of an operating system or a specific application, component, program, object, module, or series of instructions referred to as “programs”. For example, one or more programs may be used to execute specific processes described herein. The programs typically comprise one or more instructions in various memory and storage devices in the computer system 800 that, when read and executed by one or more processors, cause the computer system 800 to perform operations to execute the processes and features described herein. The processes and features described herein may be implemented in software, firmware, hardware (e.g., an application specific integrated circuit), or any combination thereof.

In one implementation, the processes and features described herein are implemented as a series of executable modules run by the computer system 800, individually or collectively in a distributed computing environment. The foregoing modules may be realized by hardware, executable modules stored on a computer-readable medium (or machine-readable medium), or a combination of both. For example, the modules may comprise a plurality or series of instructions to be executed by a processor in a hardware system, such as the processor 802. Initially, the series of instructions may be stored on a storage device, such as the mass storage 818. However, the series of instructions can be stored on any suitable computer readable storage medium. Furthermore, the series of instructions need not be stored locally, and could be received from a remote storage device, such as a server on a network, via the network interface 816. The instructions are copied from the storage device, such as the mass storage 818, into the system memory 814 and then accessed and executed by the processor 802. In various implementations, a module or modules can be executed by a processor or multiple processors in one or multiple locations, such as multiple servers in a parallel processing environment.

Examples of computer-readable media include, but are not limited to, recordable type media such as volatile and non-volatile memory devices; solid state memories; floppy and other removable disks; hard disk drives; magnetic media; optical disks (e.g., Compact Disk Read-Only Memory (CD ROMS), Digital Versatile Disks (DVDs)); other similar non-transitory (or transitory), tangible (or non-tangible) storage medium; or any type of medium suitable for storing, encoding, or carrying a series of instructions for execution by the computer system 800 to perform any one or more of the processes and features described herein.

For purposes of explanation, numerous specific details are set forth in order to provide a thorough understanding of the description. It will be apparent, however, to one skilled in the art that embodiments of the disclosure can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “one embodiment”, “an embodiment”, “other embodiments”, “one series of embodiments”, “some embodiments”, “various embodiments”, or the like means that a particular feature, design, structure, or characteristic described in connection with the embodiment is included in at least one embodiment of the disclosure. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments, but also variously omitted in other embodiments. Similarly, various features are described that may be preferences or requirements for some embodiments, but not other embodiments.

The language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer-implemented method comprising:
determining, by a computing system, at least one operation that causes a challenge-response test to be activated for authenticating a user;
determining, by the computing system, a first set of content items that each have a threshold similarity to a query content item;
determining, by the computing system, a second set of content items that each have a threshold dissimilarity to the query content item; and
providing, by the computing system, the challenge-response test for display to the user, wherein the challenge-response test presents a group of content items including the first set of content items and the second set of content items.

2. The computer-implemented method of claim 1, wherein determining, by the computing system, the first set of content items further comprises:
determining, by the computing system, a number of content items to be included in the first set;
determining, by the computing system, a respective similarity distance measurement between the query content item and each of a plurality of content items; and
selecting, by the computing system, content items from the plurality of content items to be included in the first set, wherein the respective similarity distance measurement of each of the selected content items satisfies a first threshold range.

3. The computer-implemented method of claim 1, wherein determining, by the computing system, the second set of content items further comprises:
determining, by the computing system, a number of content items to be included in the second set;
determining, by the computing system, a respective similarity distance measurement between the query content item and each of a plurality of content items; and
selecting, by the computing system, content items from the plurality of content items to be included in the second set, wherein the respective similarity distance measurement of each of the selected content items satisfies a second threshold range.

4. The computer-implemented method of claim 3, wherein determining, by the computing system, the respective similarity distance measurement between the query content item and each of the plurality of content items further comprises:
determining, by the computing system, the respective similarity distance measurement between a hash value corresponding to the query content item and a respective hash value corresponding to the content item.

5. The computer-implemented method of claim 4, wherein the similarity distance measurement is a Hamming distance between the hash value corresponding to the query content item and the respective hash value corresponding to the content item.

6. The computer-implemented method of claim 4, wherein the hash values are projected using a convolutional neural network.

7. The computer-implemented method of claim 6, wherein the convolutional neural network is trained to project the hash values based at least in part on locality-sensitive hashing.

8. The computer-implemented method of claim 6, the method further comprising:
determining, by the computing system, that a threshold number of users have identified a particular content item included in the second set of content items as being similar to the query content item; and
training, by the computing system, the convolutional neural network so that the particular content item is determined to be similar to the query content item.

9. The computer-implemented method of claim 1, wherein the challenge-response test is satisfied when a threshold number of similar content items from the group of content items have been identified, the method further comprising:
determining, by the computing system, that the user has identified the threshold number of content items in the first set; and
performing, by the computing system, the at least one operation.

10. The computer-implemented method of claim 1, wherein the challenge-response test is satisfied when a threshold number of content items similar to the query content item have been identified from the group of content items, the method further comprising:
determining, by the computing system, that the user has identified the threshold number of content items in the first set, wherein content items in the first set are similar to the query content item; and
performing, by the computing system, the at least one operation.

11. A system comprising:
at least one processor; and
a memory storing instructions that, when executed by the at least one processor, cause the system to perform:
determining at least one operation that causes a challenge-response test to be activated for authenticating a user;
determining a first set of content items that each have a threshold similarity to a query content item;
determining a second set of content items that each have a threshold dissimilarity to the query content item; and
providing the challenge-response test for display to the user, wherein the challenge-response test presents a group of content items including the first set of content items and the second set of content items.

12. The system of claim 11, wherein determining the first set of content items causes the system to further perform:
determining a number of content items to be included in the first set;
determining a respective similarity distance measurement between the query content item and each of a plurality of content items; and
selecting content items from the plurality of content items to be included in the first set, wherein the respective similarity distance measurement of each of the selected content items satisfies a first threshold range.

13. The system of claim 11, wherein determining the second set of content items causes the system to further perform:
determining a number of content items to be included in the second set;
determining a respective similarity distance measurement between the query content item and each of a plurality of content items; and
selecting content items from the plurality of content items to be included in the second set, wherein the respective similarity distance measurement of each of the selected content items satisfies a second threshold range.

14. The system of claim 13, wherein determining the respective similarity distance measurement between the query content item and each of the plurality of content items causes the system to further perform:
determining the respective similarity distance measurement between a hash value corresponding to the query content item and a respective hash value corresponding to the content item.

15. The system of claim 14, wherein the similarity distance measurement is a Hamming distance between the hash value corresponding to the query content item and the respective hash value corresponding to the content item.

16. A non-transitory computer-readable storage medium including instructions that, when executed by at least one processor of a computing system, cause the computing system to perform a method comprising:
determining at least one operation that causes a challenge-response test to be activated for authenticating a user;
determining a first set of content items that each have a threshold similarity to a query content item;
determining a second set of content items that each have a threshold dissimilarity to the query content item; and
providing the challenge-response test for display to the user, wherein the challenge-response test presents a group of content items including the first set of content items and the second set of content items.

17. The non-transitory computer-readable storage medium of claim 16, wherein determining the first set of content items causes the system to further perform:
determining a number of content items to be included in the first set;
determining a respective similarity distance measurement between the query content item and each of a plurality of content items; and
selecting content items from the plurality of content items to be included in the first set, wherein the respective similarity distance measurement of each of the selected content items satisfies a first threshold range.

18. The non-transitory computer-readable storage medium of claim 16, wherein determining the second set of content items further causes the system to further perform:
determining a number of content items to be included in the second set;
determining a respective similarity distance measurement between the query content item and each of a plurality of content items; and
selecting content items from the plurality of content items to be included in the second set, wherein the respective similarity distance measurement of each of the selected content items satisfies a second threshold range.

19. The non-transitory computer-readable storage medium of claim 18, wherein determining the respective similarity distance measurement between the query content item and each of the plurality of content items further causes the system to further perform:
determining the respective similarity distance measurement between a hash value corresponding to the query content item and a respective hash value corresponding to the content item.

20. The non-transitory computer-readable storage medium of claim 19, wherein the similarity distance measurement is a Hamming distance between the hash value corresponding to the query content item and the respective hash value corresponding to the content item.
